(19) United States
(12) Patent Application Publication
(10) Pub. No.: US 2008/0241468 A1
(43) Pub. Date: Oct. 2, 2008

(54) Method of providing marking on a ceramic structure with a chemically reactive ink

(76) Inventor: Christopher John Warren, Waverly, NY (US)

Correspondence Address: CORNING INCORPORATED, SP-TI-3-1, CORNING, NY, 14831, US

(21) Appl. No.: 12/079,800

(22) Filed: Mar. 28, 2008

Related U.S. Application Data
(60) Provisional application No. 60/921,214, filed on Mar. 30, 2007.

(51) Int. Cl. B32B 3/12; B05D 5/00; C09D 11/02

(52) U.S. Cl. 428/116; 427/287; 106/31.13

(57) ABSTRACT

A method is provided for marking a ceramic structure by applying a substance, such as an ink, onto a surface of a ceramic-forming green body structure, wherein the substance has an agent that chemically reacts with an ingredient of the green body structure during firing of the green body to produce a contrasting mark on the resulting ceramic structure. An ink containing an agent that chemically reacts with an ingredient of the green body structure is also provided. A ceramic article having a mark that includes a metal-containing compound is also provided.

### RELATED APPLICATIONS

This application claims the benefit of U.S. Provisional Application No. 60/921,214, filed Mar. 30, 2007, entitled “Method of Providing Marking on a Ceramic Structure with a Chemically Reactive Ink.”

### FIELD

This invention generally relates to providing marking on a ceramic structure, and is specifically concerned with applying a substance onto a surface of a ceramic-forming green body structure, wherein the substance has an agent that chemically reacts with an ingredient of the green body structure during firing to produce a visibly contrasting mark on a resulting ceramic structure.

### BACKGROUND

Ceramic honeycomb structures are widely used as anti-pollutant devices in the exhaust systems of automotive vehicles, both as catalytic converter substrates in automobiles, and diesel particulate filters in diesel-powered vehicles. In both applications, the ceramic honeycomb structures are formed from a matrix of thin ceramic webs which define a plurality of parallel, gas conducting channels.

Such ceramic honeycomb structures may be formed by an extrusion technique in which an extruded body is cut into segments that form green ceramic-forming bodies. These green bodies are fired at temperatures of at least 1100° C. or higher, and typically 1400° C. or higher in order to fuse the batch constituent particles present in the extruded material into a ceramic honeycomb structure. The fired bodies may be subjected to additional heating steps in which they are fired again to a lower temperatures, for example, on the order of 800° C. or more. The ceramic structures may also be subjected to a coating process that coats the gas-contacting surfaces with a washcoat, possibly containing catalytic metals.

Due to the thinness of the outer skin and the inner cell-forming webs, the substantial thermal stresses that the structures undergo during the firing processes, and the necessary mechanical handling of the green and fired bodies during the manufacturing process, defects such as internal cracks and voids may occur, as well as separations between the outer skin and the inner matrix of webs. To reduce the occurrence of such defects, it would be desirable to have a quality control procedure which allowed the manufacture to reliably trace any defective structure back to the specific originating factory, kiln, and batch. Such a procedure would allow the manufacturer to review the particular manufacturing parameters used to fabricate the defective unit and to modify its manufacturing operation in order to reduce the occurrence of such defects in future articles. Accordingly, it is a known procedure to mark, after the final firing or heating step, finished ceramic honeycomb structures with marks containing manufacturing information so that remedial manufacturing operations may be implemented.

However, the applicants have observed that such a marking procedure does not reliably result in an accurate recovery of the manufacturing information associated with a particular ceramic honeycomb structure. In particular, the applicants have observed that subsequent to the manufacture of the green bodies of such structures, different batches of green bodies from different kilns necessarily become mixed together in order to efficiently implement other stages of the fabrication process. Hence a quality control process where manufacturing information is printed on the finished ceramic honeycomb structures may not accurately reflect the actual manufacturing conditions and history of the structures.

To avoid the aforementioned problems, it is necessary to apply a mark, such as a data carrying mark, on the surface of the green bodies that ultimately form completed ceramic honeycomb structures. However, there are a number of problems associated with implementing such a method due to both the fragility of the green bodies, the high temperatures they are subjected to during the firing process, the speed with which they must be marked in order to avoid a production bottleneck, and the tendency of some inks to run or blur when printed on the green body, or to degrade or corrosively react with the unfired material forming the side wall of the green body.

### SUMMARY

The present invention relates to providing a mark on a ceramic structure by applying a substance, such as an ink, onto a surface of a ceramic-forming green body structure, wherein the substance has an agent that chemically reacts with an ingredient of the green body structure during firing of the green body to produce a visibly contrasting mark on a resulting ceramic structure. The substance may be referred to as a reacting agent, and may be applied as a liquid, solid, paste, or gel. In liquid form, the substance may be soluble or insoluble in a carrier liquid. In one aspect, a method for providing a mark on a ceramic structure is disclosed herein. In another aspect, an ink containing an agent that chemically reacts with an ingredient of the green body structure is disclosed herein. In another aspect, a ceramic article comprising a mark comprised of a metal-containing compound is disclosed herein.

In some embodiments, the method comprises the step of applying a mark on a surface of a ceramic-forming green body with an ink that includes an agent that chemically reacts with a ceramic ingredient in the green body when the green body is fired incident into a ceramic article, thereby forming a compound that visibly contrasts with adjacent, unmarked portions of said wall. In some embodiments, the method further comprises firing the green body. The green body may be fired at a temperature of between about 1100° C. and 1500° C. for 12 to 16 hours.

In some embodiments, the reacting agent in the ink comprises a soluble metal-containing species wherein the metal is one of the group consisting of Fe, Cr, Mn, Co, Mo, V and Ru; in some of these embodiments, the green body includes a titanium-containing component. The metal-containing species of the ink is preferably provided in solution form, such as in water, alcohol, methanol, oil, etc.; for example, the ink may comprise an aqueous solution of one of said metal species. In some embodiments, the metal-containing species is a soluble iron-containing species, such as iron chloride, iron acetate, or iron nitrate.

More specifically, the wall of the unfinished ceramic structure may include titania, and the ink may include an aqueous solution of an iron compound such as FeCl₂.4H₂O, FeCl₃.6H₂O and/or (FeNO₃)₂.9H₂O that forms iron titanate when the unfinished ceramic body is fired. The concentration of the iron compound is preferably at least 1M in the aqueous solution, and more preferably at least 2M.

The mark is preferably a data-carrying mark that includes selected manufacturing information, such as a two-dimensional barcode, and the method may further include the step of reading the marked after the firing step to determine if the resulting, visibly-contrasting mark includes all of the selected manufacturing information.

### DESCRIPTION OF THE DRAWINGS

FIG. 1 is a perspective view of a ceramic honeycomb structure having a wall surface portion that has been marked with an illustrative data-carrying mark in accordance with the invention;

FIG. 2A is an enlargement of the data-carrying mark illustrated on the side of the unfinished ceramic honeycomb structure illustrated in FIG. 1;

FIG. 2B is a side, cross-sectional view of the marked wall portion illustrated in FIG. 2A along the line 2B,C-2B,C prior to firing;

FIG. 2C is a side, cross-sectional view of the marked wall portion illustrated in FIG. 2A along the line 2B,C-2B,C after firing;

FIG. 3 is a side view of a marking station for implementing invention, and

FIGS. 4A and 4B are plan views of the marking station illustrated in FIG. 3 implementing the invention.

### DETAILED DESCRIPTION

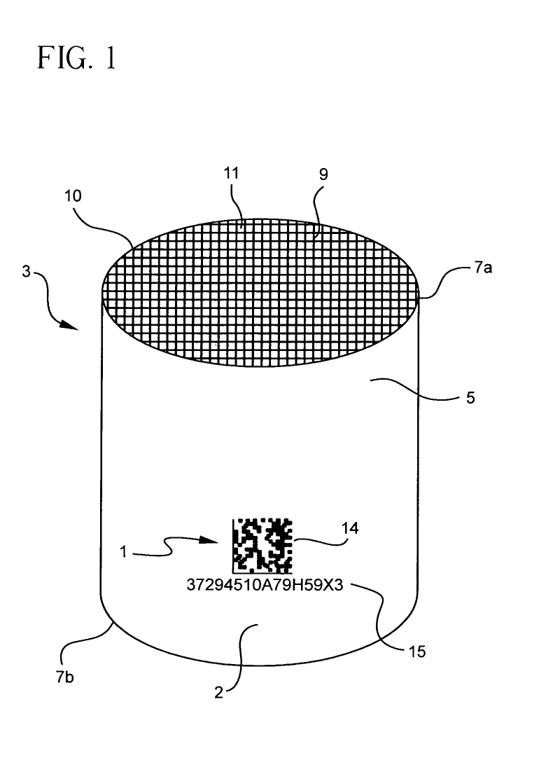

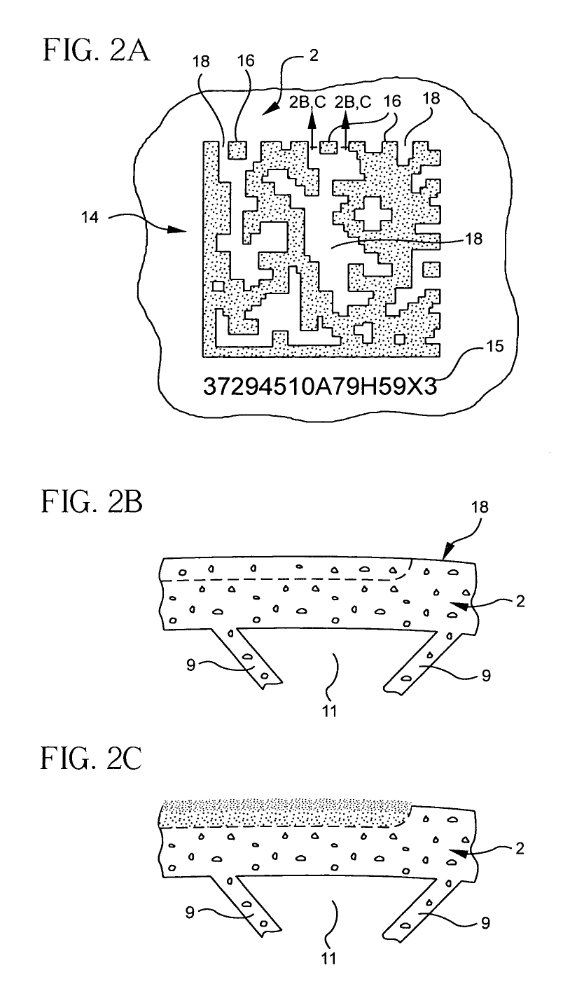

With reference now to FIG. 1, wherein like numerals designate like components throughout all of the several Figures, embodiments of the invention comprise providing a data-carrying mark 1 on the side wall surface 2 of a ceramic structure 3. A chemically reactive ink for forming such a mark 1 is also disclosed herein. In one example, the ceramic structure 3 is a ceramic honeycomb structure formed from aluminum titanate of the type used in automotive exhaust systems, although the invention is not limited to such an application, nor limited to aluminum titanate matrixes. Such ceramic structures generally have a cylindrical body 5 having open inlet and outlet ends 7a, 7b for receiving and expelling automotive exhaust gases. The exterior of such structures 3 is formed by an outer skin 10 of ceramic material. The interior of such structures 3 includes a grid-like network 9 of ceramic webs integrally connected to the inner surface of the outer skin 10 that define gas-conducting cells 11 (best seen in FIG. 2B) extending between the inlet and outlet ends 7a, 7b.

With reference to FIGS. 1 and 2A, some embodiments of the mark 1 include a machine-readable component 14 such as a two-dimensional bar code, and a human readable component 15 such as a string of alphanumeric characters. The machine-readable component 14 preferably includes a digital pattern of printed wall portions 16 and unprinted wall portions 18 in order to maximize the optical contrast between the printed and unprinted wall portions 16, 18, thereby reducing the chance of a reading error. The machine readable component 14 may of course be a one dimensional bar code or virtually any type of information carrying pattern of marked and unmarked wall portions 16, 18. However, a two-dimensional bar code is a preferred embodiment of the mark of the invention as up to 30% of such marks can be obliterated without loss of information.

FIGS. 2B and 2C illustrate the printed wall portions 16 before and after firing, respectively. The printed wall portions are formed from a layer 20 of chemically reactive ink deposited over the outer surface 21 of the skin 10. The chemically reactive ink is a preferably a metal-containing species, in some embodiments preferably a soluble metal species, that reacts with one of the ingredients, preferably one of the inorganic ceramic-forming ingredients, included within the green body that forms into the ceramic structure 3 during firing to form a chemical compound 22 that visibly contrasts with one or more portions of the fired ceramic structure 3 which is not so marked. The metal-containing species of the ink is preferably provided in solution form, such as in water, alcohol, oil, or other liquids; for example, the ink may comprise an aqueous solution of one of said metal species. In some embodiments, the metal-containing species is a soluble iron-containing species, such as iron chloride, iron acetate, or iron nitrate.

In some embodiments, the ink is mixed with a carrier liquid, which may be water, such as to form a printer ink. The soluble metal species may include one or more of the group consisting of cobalt, iron, chromium, molybdenum, manganese, vanadium, and ruthenium. In some embodiments, the ceramic-forming ingredient is titanium, titania and/or aluminum titanate and the soluble metal species is a soluable iron-containing species. In some embodiments, the reactive ink comprises one or more of the group consisting of FeCl₂.4H₂O, FeCl₃.6H₂O and (FeNO₃)₂.9H₂O, and the green body that results in the ceramic structure 3 after firing comprises aluminum titanate, such that a visibly contrasting compound in the form of iron titanate forms the layer 22 when the green body is fired to a temperature of between about 1100° C. to 1500° C. While an aqueous concentration of 1M is capable of creating a visibly contrasting layer 22 that visibly produces marked portions 16 on the side wall 2 of a ceramic structure 3, an aqueous concentration of 2M to 3M can be more effective. Also, while FeCl₂.4H₂O, FeCl₃.6H₂O and/or (FeNO₃)₂.9H₂O are effective in producing a visibly contrasting layer 22 of iron titanate on a wall 2 of an aluminum titanate ceramic structure 3, FeCl₃.6H₂O is preferred over (FeNO₃)₂.9H₂O for its ability to create a more visibly contrasting layer 22 at a same level of concentration. It should be noted that both of these iron-containing compounds also demonstrate some ability to produce a visibly perceptible mark 1 on the side of a cordierite ceramic structure 3, as well as other ceramic materials.

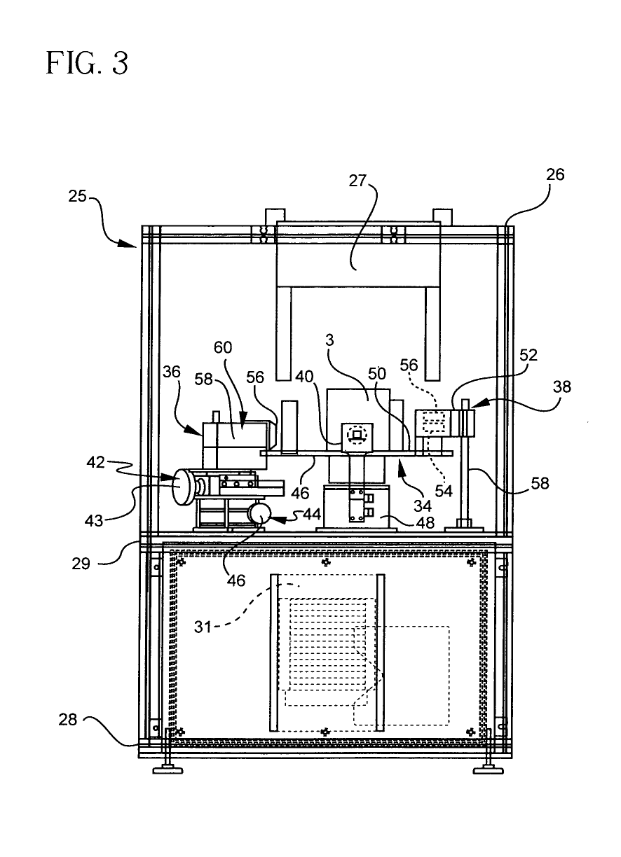

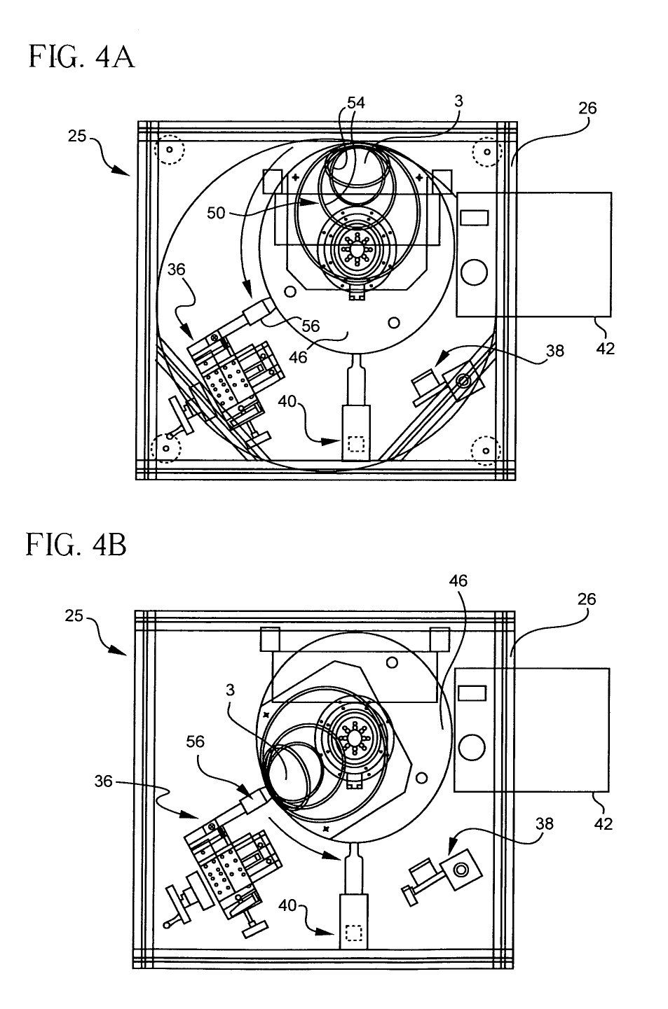

With reference now to FIGS. 3 and 4A and 4B, the green body 12 of the ceramic structure 3 is preferably marked in a marking station 25. The marking station 25 includes an upper frame 26 that slidably supports a crane-like grappling device 27. Marking station 25 further includes a lower shelf 28 and an upper shelf 29. The lower shelf 28 supports a programmable logic controller 31 which controls the operation of the various components mounted on the upper shelf 29. The upper shelf 29 supports a moving assembly 34, a printer 36 for printing the data-carrying mark 1 on a green body 12, an optical reader 38 for reading and determining the overall equality of the printed mark 1, a dryer 40 for drying the ink that forms the mark 1, and a bar code removing assembly 42 (shown in FIGS. 4A and 4B) for removing defectively-printed marks from the a green body 12 in the event of a malfunction Each of these principal components of the station 25 will now be described in more detail.

The moving assembly 34 includes a turntable 46 rotatably mounted on a driver 48. Although not specifically shown in the drawings, the driver 48 is formed from a combination of a step servo motor whose output is connected to the rotatably mounted turntable 46 via a drive train. The step servo motor of the driver 48 is connected to a power source (also not shown) which in turn is controlled by the programmable logic controller 31. The controller 31 controls the specific angle that the turntable 46 rotates by controlling the number of power pulses conducted to the step servo motor in a manner well known in the digital control arts. The moving assembly 34 further includes a template 50 formed from a plate 52 that lies on top of the turntable 46. The plate 52 has a recess 54 which is complementary in shape to the bottom edges of a particular model of green body 12. The template 50 includes a set of pins (not shown) that position the plate 52 in proper alignment with the top surface of the turntable 46. While the template 50 has been referred to thus far in singular terms, the station 25 preferably includes a plurality of templates 50 (indicated in FIG. 4A), each of which has a recess 54 that corresponds to a different sized green body 12. All of these templates 50 serve to position their respective green bodies 12 such that a side wall of the structure 3 is tangent with the outer periphery of the turntable 46. Such positioning insures that the printer 36 and optical reader 38 will be spaced a proper distance from the side wall 2 of the green body 12, regardless of the particular size of the green body 12 being marked in the station 25.

The printer 36 includes an ink jet print head 36 which preferably has at least two ink jets (not shown) so as to be able to expeditiously print a mark 1 that includes both a two dimensional bar code 14, and a human-readable alphanumeric data string 15. Printer 36 is provided with an ink reservoir 58 for storing an ink as previously described that includes an agent that chemically reacts with at least one of the ceramic ingredients of the green body 12 that forms the ceramic structure 3 after firing.

With reference now to FIG. 3, a green body 12 (which is a precursor to a ceramic honeycomb structure 3) is first lowered onto the turntable 46 of the conveyor assembly 34 via the crane-like grappling device 27 into the recess 54 of plate 52. The programmable logic controller 31 next selects a unique data carrying mark 1 to be printed on the side wall 2 of the green body 12 that includes a machine-readable component 14 and a human-readable component 15. With reference now to FIGS. 4A and 4B, controller 31 next proceeds to actuate the driver 48 of the turntable 46 to position the sidewall 2 of the structure 12 in front of the ink jet print head 56 of the printer 36. The programmable logic controller 31 actuates the print head 56 to print a pattern of marked portions 16 on the wall 2 that define the pre-selected machine-readable component 14 and human readable component 15. The print head 56 accomplishes this by applying droplets of the previously described ink containing FeCl₂.4H₂O, FeCl₃.6H₂O and/or (FeNO₃)₂.9H₂O on the marked portions 16 until a layer 20 of chemically reactive ink permeates into the outer skin 10 of the green body 12, as shown in phantom in FIG. 2B.

The green body 12 is then fired at a temperature of between about 1100° C. to 1500° C. for 12 hours or more to form the aluminum titanate (or other ceramic-forming ingredients that make up the green body) into a ceramic structure 3. During this time, the iron in the FeCl₂.4H₂O, FeCl₃.6H₂O or (FeNO₃)₂.9H₂O reacts with the titanium present in the green body of the structure 3 to form a visibly contrasting layer 22 of iron titanate, which is essentially black in color and which in turn forms the marked portions 16 on the wall 2 of the structure 3.

In some embodiments, a ceramic article is disclosed herein comprising a honeycomb structure comprising a surface having a visibly contrasting mark comprised of a metal-containing compound; in some of these embodiments, the metal-containing compound comprises iron. In some embodiments, the mark comprises iron titanate.

In some embodiments, application of the reactive ink on the green body results in a visibly contrasting mark, before the reactive ink reacts with the green body, relative to a portion of the green body to which the reactive ink is not applied. In other embodiments, application of the ink onto the surface of the green body does not result in a visibly contrasting mark before the reactive ink reacts with the green body.

In some embodiments, the present invention comprises a method for applying or printing a data-carrying mark on the surface (such as a peripheral wall) of a green structure without subjecting the thin sidewalls of such structures to potentially damaging pressure, wherein the structure is capable of withstanding the firing temperatures at or above 1100° C., or even at or above 1400° C. for time periods of 12 to 16 hours. In some embodiments, the method comprises printing a unique mark on each one of a particular batch of green ceramic-forming structures, so that the manufacturing history of each particular resultant ceramic honeycomb structure (such as date of manufacture, specific factory, kiln and batch) can be accurately traced. Preferably, the information contained in the resulting mark would be maintained even if a portion of the mark were obliterated during the shipment or use of the ceramic honeycomb structure. Preferably, the marking system disclosed herein is rapid and reliable and compatible with high-speed manufacturing techniques so as not to create an expensive production bottleneck. The ink used to form the mark is preferably able to survive firing temperatures of at least 800° C., or even 1100° C. or more, or even 1300° C. or more, and chemically compatible with the unfired material forming the body. Preferably, the ink does not blur or run when printed, and the ink should create a clear mark that does not crack or peel. Additionally, the ink preferably does not degrade or corrosively react with the ceramic material forming the wall of the structure during any phase of the manufacturing process, and further preferably visibly contrasts not only against the fired ceramic material forming the finished structure, but also against any catalytic washcoat applied to the structure.

While the invention has been described in this section in terms of a method for marking the green body of a ceramic structure, the invention also encompasses an ink having an chemical agent that reacts to form a visibly contrasting compound upon the firing of the green body.

Different modifications, additions, and variations of this invention may become evident to the persons in the art. All such variations, additions, and modifications are encompassed within the scope of this invention, which is limited only by the appended claims, and the equivalents thereto.

What is claimed is:

1. A method for providing mark on a ceramic structure, comprising the step of:
applying onto a portion of a green body an ink that comprises an agent that chemically reacts with an ingredient in said green body when said green body is fired to form the ceramic structure and forms a mark that visibly contrasts with an unmarked portion of the ceramic structure.

2. The method for marking of claim 1, further comprising a step of firing said green body after said applying step such that said mark is formed on said ceramic structure.

3. The method for marking of claim 2, wherein said mark is a data-carrying mark.

4. The method for marking of claim 3, further including the step of reading the mark.

5. The method for marking of claim 1, wherein said green body comprises a titanium containing component.

6. The method for marking of claim 5, wherein said titanium-containing component comprises one or both of aluminum titanate and titania.

7. The method for marking of claim 1, wherein said agent of said ink comprises a metal-containing species.

8. The method for marking of claim 7, wherein said soluble metal-containing species is one of the group consisting of Fe, Cr, Mn, Co, Mo, V, and Ru.

9. The method for marking of claim 1, wherein said ink comprises an iron compound.

10. The method for marking of claim 1, wherein said ink comprises an iron compound that forms iron titanate when said green body is fired.

11. The method for marking of claim 9, wherein said iron compound is one of the group consisting of FeCl₂.4H₂O, FeCl₃.6H₂O and (FeNO₃)₂.9H₂O.

12. The method for marking of claim 1, wherein said ink is an aqueous solution of one or more iron compounds.

13. The method for marking of claim 1, wherein said ink is an aqueous solution of one or more iron compounds at a concentration greater than or equal to 1M.

14. The method for marking of claim 1, wherein said ink is an aqueous solution of one or more iron compounds at a concentration greater than or equal to 2M.

15. The method for marking of claim 2, wherein said green body is fired at a temperature of at least 1100° C.

16. The method for marking of claim 2, wherein said green body is fired at a temperature of at least 1300° C.

17. An ink composition for providing marking on a ceramic structure, comprising an agent that chemically reacts with an ingredient in a green body when the green body is fired into the ceramic structure to form a compound which visibly contrasts with an unmarked portion of said structure.

18. The ink composition defined in claim 17, wherein said green body comprises a titanium-containing component and said composition comprises an iron-containing species that reacts with the titanium-containing component to form iron titanate when said green body is fired.

19. The ink composition defined in claim 17, wherein said ink comprises an aqueous solution of said agent.

20. A method for marking a ceramic structure, comprising the step of:
applying onto a green body an ink that comprises a metal-containing species, wherein the green body comprises a ceramic-forming component, then
firing said green body to form the ceramic structure, said firing causing a metal in the metal-containing species to react with the ceramic-forming component, thereby forming a mark on the ceramic structure that visibly contrasts with adjacent, unmarked portions of the ceramic structure.

21. The method of claim 20 wherein the ceramic-forming component is a titanium-containing component.

22. The method of claim 20 wherein the ink comprises a carrier liquid, and the metal-containing species is soluble in the carrier liquid.

23. The method of claim 20 wherein the ink comprises a carrier liquid, and the metal-containing species is insoluble in the carrier liquid.

24. A ceramic article comprising a honeycomb structure comprising a surface having a visibly contrasting mark comprised of a metal-containing compound.

25. The ceramic article of claim 24 wherein the metal-containing compound comprises iron.

26. The ceramic article of claim 24 wherein the mark comprises iron titanate.
